(19) United States
(12) Patent Application Publication
(10) Pub. No.: US 2020/0087466 A1
(43) Pub. Date: Mar. 19, 2020

(54) LASER-INDUCED GRAPHENE FORMATION IN POLYMER COMPOSITIONS

(71) Applicant: SABIC Global Technologies, B.V., Bergen op Zoom (NL)

(72) Inventors: Shahram Shafaei, Bergen op Zoom (NL); Kapil Chandrakant Sheth, Evansville, IN (US); Franciscus Petrus Maria Mercx, Bergen op Zoom (NL); François Guillaume Sébastien Courtecuisse, Bergen op Zoom (NL)

(21) Appl. No.: 16/569,046

(22) Filed: Sep. 12, 2019

(30) Foreign Application Priority Data
Sep. 14, 2018 (EP) 18194623.7

(51) Int. Cl. C08J 3/28; C08K 3/04

(52) U.S. Cl. CPC C08J 3/28; B82Y 30/00; C08K 3/042

(57) ABSTRACT

A method for forming a polymer/graphene nanocomposite includes providing a polymer matrix comprising a clear polymer and an additive effective to induce graphitization of the polymer at a wavelength in a range of 8.3 to 11 μm, and irradiating the polymer matrix with radiation comprising a wavelength in a range of 8.3 to 11 μm to provide the polymer/graphene nanocomposite.

### CROSS REFERENCE TO RELATED APPLICATIONS

This application claims priority to and the benefit of European Application No. 18194623.7, filed Sep. 14, 2018, and all the benefits accruing therefrom under 35 U.S.C. § 119, the content of which in its entirety is herein incorporated by reference.

### BACKGROUND

Polymer/graphene nanocomposites can have significantly improved properties, such as improved mechanical properties, thermal and electrical conductivities, and gas barrier properties. Distribution of the graphene within the polymer matrix, as well as the interfacial bonding between the graphene and the host matrix are key factors that can affect such properties. Mixing techniques to disperse graphene nanoparticles in a desired polymer matrix include solution casting, melt blending, in situ polymerization, electrospinning, and electrodeposition. Disadvantages of mixing techniques can include aggregation of the graphene nanoparticles, poor dispersion, and noncovalent interactions during the mixing.

Methods for the production of graphene in a polymer using laser irradiation have been described. However, it appears that not all polymers are susceptible to the formation of graphene using such methods.

Accordingly, a non-mixing processing method for incorporation of graphene into polymers would be advantageous. It would be a further advantage if the method could be adapted for use in a wide variety of polymers.

### BRIEF DESCRIPTION

A method for forming a polymer/graphene nanocomposite includes providing a polymer matrix including a clear polymer and an additive effective to induce graphitization of the polymer at a wavelength in a range of 8.3 to 11 μm; and irradiating the polymer matrix with a wavelength in a range of 8.3 to 11 μm to provide the polymer/graphene nanocomposite.

A polymer/graphene nanocomposite made by the above method is disclosed.

A polymer/graphene nanocomposite includes a clear polymer, combination thereof; and polymer-derived graphene.

Articles comprising the polymer/graphene nanocomposite are disclosed.

The above described and other features are exemplified by the following figures, detailed description, and Examples.

### BRIEF DESCRIPTION OF THE DRAWINGS

The following figures are exemplary embodiments wherein the like elements are numbered alike.

FIG. 1 is an SEM image of the laser irradiated polymer of Comparative Example 1;

FIG. 2 is an SEM image of the laser irradiated polymer of Example 1;

FIG. 3 is a Raman spectrum of the laser irradiated polymer of Comparative Example 1 and Example 1;

FIG. 4 is an SEM image of the laser irradiated polymer of Comparative Example 3;

FIG. 5 is an SEM image of the laser irradiated polymer of Example 3;

FIG. 6 is a Raman spectrum of the laser irradiated polymer of Comparative Example 3 and Example 3;

FIG. 7 is an SEM image of the laser irradiated polymer of Comparative Example 4;

FIG. 8 is an SEM image of the laser irradiated polymer of Example 4;

FIG. 9 is a Raman spectrum of the laser irradiated polymer of Comparative Example 4 and Example 4;

FIG. 10 is a Fourier-transform infrared spectrum of mica used in Examples 1-4 and lignin used in Examples 5, 10, and 15; and

FIG. 11 is a Fourier-transform infrared spectrum for polycarbonate without mica.

### DETAILED DESCRIPTION

It has been discovered by the inventors hereof that polymers that do not ordinarily undergo graphitization under laser irradiation can do so in the presence of certain additives to provide polymer/graphene nanocomposites. Such graphitization can provide improved properties to the polymers. For example, while clear polymers including the additives do not exhibit desirable electrical conductivity after laser irradiation, the same clear polymers including the additive do exhibit desirable electrical conductivity. In a further advantage, the graphene particles exhibit good adhesion to the polymer matrix after laser irradiation. Use of irradiation to produce polymer/graphene nanocomposites can obviate one or more disadvantages of using mixing methods to manufacture such nanocomposites.

In particular, laser-induced graphene formation is a non-mixing method to produce polymer/graphene nanocomposites. In the method, a polymer matrix containing an additive that induces graphene formation under irradiation conditions as disclosed herein is exposed to a laser source and graphene is formed from the polymer of the polymer matrix.

Laser-induced graphene formation is a non-mixing method to produce polymer/graphene nanocomposites. Graphene as used herein includes undoped graphene and heteroatom-doped graphene such as N-doped quantum dots (NGQDs) and S-doped quantum dots (SGQDs). In an embodiment, the graphene is undoped graphene only. Polymer substrates are exposed to a laser source and graphene is formed from the polymer. Graphene layers are generated on a surface of the polymer substrate, resulting in new surface characteristics. Such characteristics can include increased surface area, thermal conductivity, electrical conductivity, hydrophobicity, antimicrobial properties, or a combination thereof. The performance of such nanocomposites depends on the polymer, the additives, the morphology of the substrate, and laser parameters. Laser-induced graphene formation can provide greater conductivity than mixing methods, which typically use graphite. Accordingly, laser-induced graphene formation can provide improved conductivity compared to polymers including graphene produced by mixing methods.

Laser-induced graphene formation can also be used to produce localized concentrations of graphene in an article. For example, an article (e.g., a substrate layer) can be masked and irradiated to produce graphene in the unmasked regions. This technique allows the production of complex articles that would otherwise need to be manufactured by making graphene-containing and nongraphene-containing parts, and assembling the parts to provide the graphene- and nongraphene-containing regions.

As stated above, the laser-induced graphitization is carried out on a polymer matrix that comprises a clear polymer and an additive. As used herein, a “clear polymer” is one that allows the passage of radiation having a wavelength in a range of 8.3 to 11 micrometer (μm), or 8.3 to 10.6 μm. For example, a sample of a clear polymer having a thickness of one centimeter (and no additive) allows passage of 100%, or at least 90%, or at least 80%, or at least 60%, or at least 30% of impinging radiation having a wavelength in a range of 8.3 to 11 μm, or 8.3 to 10.6 μm. Certain miscible blends of polymers can also be used. While visual transparency is not necessarily related to the passage of radiation having a wavelength in a range of 8.3 to 11 μm, or 8.3 to 10.6 μm, in some embodiments the polymer is visually transparent. For example, in some embodiments the clear polymers have a haze of less than 15%, or less than 10%, or less than 5%, or less than 1%, each measured according to ASTM D1003-00 using the color space CIE1931 (Illuminant C and a 2° observer) at a sample thickness of 2.5 mm.

In some preferred embodiments the clear polymer does not graphitize under the laser irradiation conditions disclosed herein in the absence of the additive.

Many polymers or miscible polymer blends can be rendered clear (as that term is used herein) when processed under ordinary processing conditions, e.g., ordinary extrusion and/or molding conditions. Such polymers can include, for example, thermoplastic polymers such as polyacetals (e.g., polyoxyethylene and polyoxymethylene), poly(C₁₋₆ alkyl)acrylates, polyacrylamides (including unsubstituted and mono-N- and di-N-(C₁₋₈ alkyl)acrylamides), polyacrylonitriles, polyamides (e.g., aliphatic polyamides, polyphthalamides, and polyaramides), polyamideimides, polyanhydrides, polyarylene ethers (e.g., polyphenylene ethers), polyarylene ether ketones (e.g., polyether ether ketones (PEEK) and polyether ketone ketones (PEKK), polyarylene ketones, polyarylene sulfides (e.g., polyphenylene sulfides (PPS)), polyarylene sulfones (e.g., polyethersulfones (PES), polyphenylene sulfones (PPS), and the like), polybenzothiazoles, polybenzoxazoles, polybenzimidazoles, polycarbonates (including homopolycarbonates and polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetherimides (including copolymers such as polyetherimide-siloxane copolymers), polyimides (including copolymers such as polyimide-siloxane copolymers), poly(C₁₋₆ alkyl)methacrylates, polymethacrylamides (including unsubstituted and mono-N- and di-N-(C₁₋₈ alkyl)acrylamides), polyolefins (e.g., polyethylenes, such as high density polyethylene (HDPE), low density polyethylene (LDPE), and linear low density polyethylene (LLDPE), polypropylenes, and their halogenated derivatives (such as polytetrafluoroethylenes), and their copolymers, for example ethylene-alpha-olefin copolymers, polyoxadiazoles, polyoxymethylenes, polyphthalides, polysilazanes, polysiloxanes (silicones), polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, vinyl polymers (including polyvinyl alcohols, polyvinyl esters, polyvinyl ethers, polyvinyl halides (e.g, polyvinyl fluoride), polyvinyl ketones, polyvinyl nitriles, polyvinyl thioethers, and polyvinylidene fluorides), or the like. A combination of at least one of the foregoing thermoplastic polymers can be used.

Thermoset polymers, when clear as defined herein, can also be used in some embodiments, for example alkyds, bismaleimide polymers, bismaleimide triazine polymers, cyanate ester polymers, benzocyclobutene polymers, diallyl phthalate polymers, epoxies, hydroxymethylfuran polymers, melamine-formaldehyde polymers, phenolics (including phenol-formaldehyde polymers such as novolacs and resoles), benzoxazines, polydienes such as polybutadienes (including homopolymers and copolymers thereof, e.g., poly(butadiene-isoprene)), polyisocyanates, polyureas, polyurethanes, silicones, triallyl cyanurate polymers, triallyl isocyanurate polymers, and certain silicones. A combination thereof can be used.

In an embodiment, the clear polymer is a polycarbonate (PC), polyetherimide (PEI), polyester such as polyethylene terephthalate (PET) and polyethylene naphthalate (PEN)), poly(methyl adamantine methacrylate) (PMAMA), polystyrene (PS), melamine-formaldehyde resin, polypropylene (PP), polyamide (PA), poly(methyl methacrylate) (PMMA), poly(arylene ether) (PAE) (such as poly(p-phenylene oxide) (PPO)), or polyurethane (PU). Certain miscible blends of polymers are also clear under ordinary processing conditions, for example.

In an embodiment, the clear polymer can include at least one polycarbonate. Exemplary polycarbonates include a polycarbonate homopolymer, copolycarbonate, poly(carbonate-ester), poly(carbonate-siloxane), or poly(carbonate-ester-siloxane). In an embodiment, a poly(carbonate-ester) is used. “Polycarbonate” as used herein means a homopolymer or copolymer having repeating structural carbonate units of formula (1)

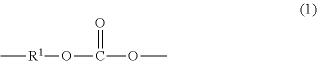

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

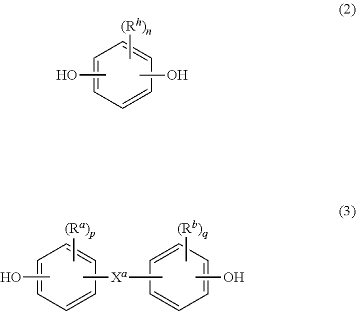

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of dihydroxy compounds that can be used are described, for example, in WO 2013/175448 A1, US 2014/0295363, and WO 2014/072923. Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

The polycarbonate can be a copolycarbonate, i.e., a polycarbonate having two or more different carbonate units. Specific copolycarbonates include bisphenol A carbonate units and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade name XHT from SABIC), a copolymer comprising bisphenol A carbonate units and 1,1-bis(4-hydroxy-3-methylphenyl)cyclohexane carbonate units (a BPA-DMBPC copolymer commercially available under the trade name DMC from SABIC), and a copolymer comprising bisphenol A carbonate units and isophorone bisphenol carbonate units (available, for example, under the trade name APEC from Bayer).

Poly(carbonate-ester)s further contain, in addition to recurring carbonate chain units of formula (1), repeating ester units of formula (4)

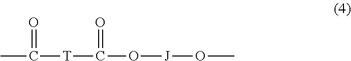

wherein J is a divalent group derived from a dihydroxy compound (which includes a reactive derivative thereof), and can be, for example, a C₁₋₁₀ alkylene, a C₆₋₂₀ cycloalkylene, a C₅₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₁₋₂₀ alkylene, a C₅₋₂₀ cycloalkylene, or a C₆₋₂₀ arylene. Copolyesters containing a combination of different T or J groups can be used. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,4-cyclohexane diol, 1,4-hydroxymethylcyclohexane, or a combination thereof. Aliphatic dicarboxylic acids that can be used include C₅₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,4-cyclohexane dicarboxylic acid, or a combination thereof. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(ester-carbonate)s can vary from 1:99 to 30:70, specifically 2:98 to 25:75, more specifically 3:97 to 20:80, or from 5:95 to 15:85.

Poly(carbonate aliphatic ester)s can be used, such as those comprising bisphenol A carbonate units and sebacic acid-bisphenol A ester units, such as those commercially available under the trade name LEXAN HFD from SABIC.

A specific poly(carbonate-ester) that can be used is a poly(aromatic ester-carbonate) comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units. Another specific poly(ester-carbonate) comprises bisphenol A carbonate units and resorcinol isophthalate and terephthalate units. Such poly(carbonate-ester)s are commercially available under the trade name LEXAN SLX from SABIC.

In a specific embodiment, the poly(carbonate-esters) are fully aromatic, comprising bisphenol A carbonate units and arylate ester units, specifically ITR units, and can have an Mw of 2,000 to 100,000 Dalton (Da), or 3,000 to 75,000 Da, or 4,000 to 50,000 Da, or 5,000 to 35,000 Da, or 17,000 to 30,000 g/mol.

A poly(carbonate-siloxane) can be used, comprising carbonate units and diorganosiloxane units. In an embodiment, the poly(carbonate-siloxane) comprises bisphenol A carbonate units and dimethylsiloxane units, for example blocks containing 5 to 200 dimethylsiloxane units, such as those commercially available under the trade name EXL from SABIC.

Other specific polycarbonates that can be used include poly(carbonate-ester-siloxane)s comprising carbonate units, ester units and diorganosiloxane units. In an embodiment, the include poly(carbonate-ester-siloxane)s comprise bisphenol A carbonate units, isophthalate-terephthalate-bisphenol A ester units, and blocks containing 5 to 200 dimethylsiloxane units. These are commercially available under the trade name FST from SABIC.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight (Mw) of 10,000 to 200,000 Daltons, specifically 20,000 to 100,000 Daltons, as measured by gel permeation chromatography (GPC), using a crosslinked styrene-divinylbenzene column and calibrated to bisphenol A homopolycarbonate references. GPC samples are prepared at a concentration of 1 mg per ml, and are eluted at a flow rate of 1.5 ml per minute.

In a specific embodiment, the polycarbonate can include a homopolycarbonate, preferably a bisphenol A homopolycarbonate, more preferably a preferably a bisphenol A homopolycarbonate having a weight average molecular weight of 19,000 to 22,000 Dalton.

As stated above, a combination of different polymers can be used. In an embodiment, the clear polymer can include a polycarbonate and a polyetherimide. For example, the polycarbonate can be present in an amount of 10 to 90 volume percent; and the polyetherimide can be present in an amount of 90 to 10 volume percent, each based on a total volume of the clear polymer.

In an embodiment, the clear polymer can include a poly(carbonate-ester) and a polyetherimide. For example, the poly(carbonate-ester) can be present in an amount of 10 to 90 volume percent; and the polyetherimide can be present in an amount of 90 to 10 volume percent, each based on a total volume of the clear polymer.

Polyetherimides comprise more than 1, for example 2 to 1000, or 5 to 500, or 10 to 100 structural units of formula (6)

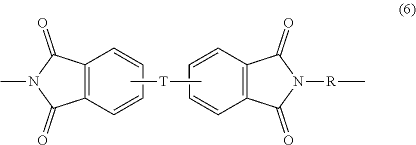

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (7)

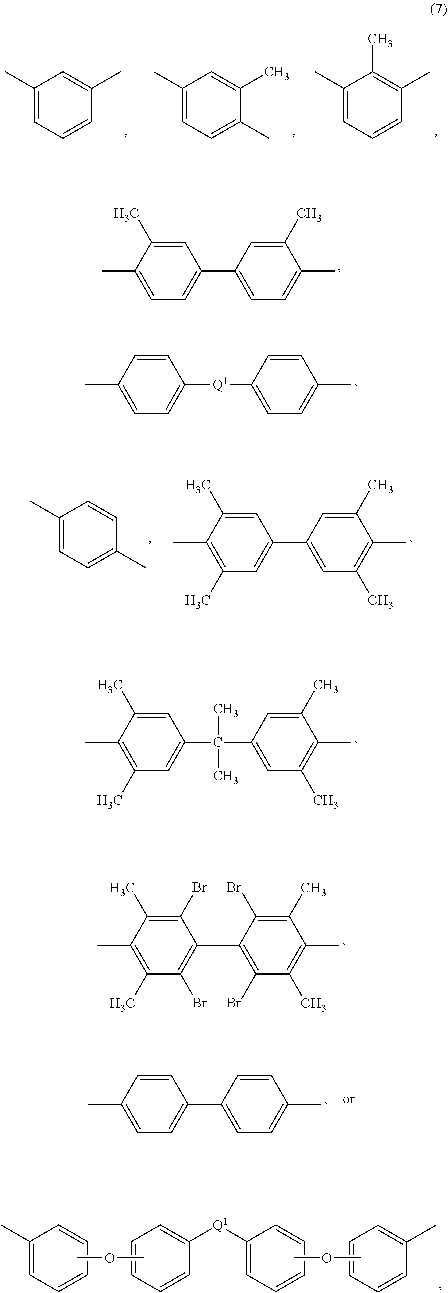

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination thereof. In some embodiments, at least 10 mole percent or at least 50 mole percent of the R groups contain sulfone groups, and in other embodiments no R groups contain sulfone groups.

Further in formula (6), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups of formula (8)

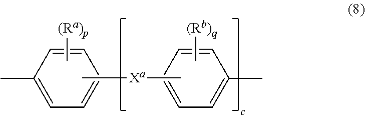

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (8a)

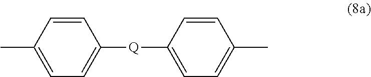

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (8a) is 2,2-isopropylidene.

In an embodiment, in formula (6), R is m-phenylene, p-phenylene, or a combination thereof, and T is —O—Z—O— wherein Z is a divalent group of formula (8a). Alternatively, R is m-phenylene, p-phenylene, or a combination thereof, and T is —O—Z—O wherein Z is a divalent group of formula (8a) and Q is 2,2-isopropylidene. Alternatively, the polyetherimide can be a copolymer comprising additional structural polyetherimide units of formula (6) wherein at least 50 mole percent (mol %) of the R groups are bis(4,4′-phenylene)sulfone, bis(3,4′-phenylene)sulfone, bis(3,3′-phenylene)sulfone, or a combination thereof, and the remaining R groups are p-phenylene, m-phenylene or a combination thereof; and Z is 2,2-(4-phenylene)isopropylidene, i.e., a bisphenol A moiety. In some embodiments, the polyetherimide is a copolymer that optionally comprises additional structural imide units that are not polyetherimide units. These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide can be a copolymer, for example, a poly(etherimide-sulfone) copolymer comprising structural units of formula (1) wherein at least 50 mole % of the R groups are of formula (2) wherein Q¹ is —SO₂— and the remaining R groups are independently p-phenylene or m-phenylene or a combination thereof; and Z is 2,2′-(4-phenylene)isopropylidene. In an embodiment, polyetherimide sulfone can include a phthalic anhydride end group, an example of which is commercially available under the trade name EXTEM XH1015 from SABIC.

The clear polymer (or combination of polymers) is combined with an additive that is effective to induce graphitization of the polymer at a wavelength in a range of 8.3 to 11 μm, or 8.3 to 10.6 μm, as described herein. A wide variety of materials can be used as this additive, and include mica, a phenol resin, a pigment, a dye, a biopolymer such as cellulose or lignin, or a combination thereof. In an embodiment, the additive can have an absorbance of greater than 2 in a range of 9 to 11 μm, more preferably 10.4 to 10.8 μm

The additive is used in an effective amount. For example, the additive can be present in an amount in a range of 0.05 to 15 volume percent, preferably 0.1 to 10 volume percent, more preferably 0.5 to 5 volume percent, based on a total volume of the polymer matrix.

In an embodiment, the unfilled polymer matrix can have an absorbance of less than 1 in a range of 9 to 11 μm, more preferably 10.4 to 10.8 μm

Irradiation to induce graphitization can be carried out using a carbon dioxide infrared laser. Irradiation can include a wavelength in a range of 8.3 to 11 μm, or 8.3 to 10.6 μm. Exemplary operating conditions include power in a range of 0.1 to 0.6 watts (W), laser speed in a range of 1.7 to 2.5 centimeter per second (cm s⁻¹), pulse duration in a range of 10 to 30 microseconds (μs), and resolution in a range of 500 to 1,000 pixels per inch (ppi).

The polymer/graphene nanocomposite formed by the irradiation can have a surface electrical conductivity of 1 to 2,000 S/m. In some embodiments, the polymer/graphene nanocomposite can have a surface electrical conductivity that is at least 10%, or at least 20% greater compared to a surface electrical conductivity of a second polymer matrix comprising the same clear polymer but without the additive, the second polymer matrix having been irradiated under the same conditions as the polymer/graphene nanocomposite.

The polymer/graphene nanocomposite formed by the irradiation can have a bulk electrical conductivity of 1 to 2,000 S/m. In some embodiments, the polymer/graphene nanocomposite can have a bulk electrical conductivity that is at least 10%, or at least 20% greater compared to a surface electrical conductivity of a second polymer matrix comprising the same clear polymer but without the additive, the second polymer matrix having been irradiated under the same conditions as the polymer/graphene nanocomposite.

The polymer/graphene nanocomposite formed by the irradiation can have a degree of graphitization of 0.5 to 2.0, for example 0.5 to 1.0, determined as described below.

In an embodiment, the polymer/graphene nanocomposite can have a greater degree of adhesion of the graphene compared to a second polymer matrix comprising the same clear polymer but without the additive, the second polymer matrix having been irradiated under the same conditions as the polymer/graphene nanocomposite.

The properties of the polymer/graphene nanocomposites can be adjusted by varying the polymer used, the morphology of the substrate, and the laser (irradiation) parameters. For example, the above method can further include adjusting one or more of the operating conditions of the laser to adjust a property of the polymer/graphene nanocomposite, such as the wavelength, power, pulse, speed, gas environment, or the like.

The polymer/graphene nanocomposite can be used in a wide variety of articles, in particular articles using surface conductivity.

This disclosure is further illustrated by the following examples, which are non-limiting.

### EXAMPLES

Components used in the Examples and Comparative Examples are provided in Table 1.

TABLE 1

| Compo- | | |
|---|---|---|
| nent | Description | Source |
| PEI | Polyetherimide derived from bisphenol A | SABIC |
| | and meta-phenylene diamine, Tg = 215 to | |
| | 219° C.; Mn = 20,000 to 22,000 Da; Mw = | |
| | 52,000 to 56,000 Da; polydispersity = 2.4 | |
| | to 26. (available as ULTEM ™ 1000) | |
| PC-1 | Bisphenol A homopolycarbonate having an | SABIC |
| | Mw of 28,000 to 32,000 Da (trade name | |
| | LEXAN 105) | |
| PC-2 | Bisphenol A homopolycarbonate having an | SABIC |
| | Mw of 19,000 to 22,000 Da (trade name | |
| | LEXAN 175) | |
| ITR-PC | Isophthaloyl and terephthaloyl resorcinol | SABIC |
| | poly(carbonate-ester) (trade name SLX) | |
| Mica-1 | Mica powder having dimensions of 30-80 μm | Imerys Mica |
| | (trade name 200-HK) | Suzorite Inc. |
| Mica-2 | Mica powder having dimensions of 2-14 μm | Aspanger |
| | (trade name SFG20) | Bergbau und |
| | | Mineralwerke |
| | | GmbH |
| PETS | Pentaerythritol stearate (>90% esterified) | FACI |
| AO | Tris(di-t-butylphenyl)phosphite (anti- | Everspring |
| | oxidant) | |
| Lignin | | AGING CHEM |
| Resin | Phenol formaldehyde resin | Novolac |

Compounding and extrusion was performed at standard conditions. In particular, extrusion of all materials was performed on a 25 mm Werner-Pfleiderer ZAK twin-screw extruder (L/D ratio of 33/1) with a vacuum port located near the die face. The extruder has 9 zones, which were set at temperatures of 40° C. (feed zone), 200° C. (zone 1), 250° C. (zone 2), 270° C. (zone 3), and 280-300° C. (zone 4 to 8). Screw speed was 300 rpm and throughput was between 15 and 25 kg/hr.

For testing, color plaques (60×60×2.0 millimeters (mm)) were prepared by drying the compositions at 135° C. for 4 hours, then by molding after on a 45-ton Engel molding machine with 22 mm screw or 75-ton Engel molding machine with 30 mm screw operating at a temperature around 310° C. with a mold temperature of 100° C. Films (210×297×0.250 mm and 210×297×0.250 mm) were obtained from SABIC.

Carbon dioxide infrared laser irradiation conditions for the Comparative Examples and the Examples are provided in Table 2. Irradiation was further conducted under ambient conditions of temperature and pressure.

TABLE 2

| Parameter | Value |
|---|---|
| Wavelength (μm) | 10.6 |
| Power (W) | 0.1-0.6 |
| Laser speed (cms⁻¹) | 1.7-2.5 |
| Pulse duration (μs) | 14.6 |
| Resolution (pixels per inch) | 600 |

Melt volume rate (MVR) was determined at 300° C./1.2 kg or at 360° C./5.0 kg in accordance with ISO 1133. Results are reported in units of cm³/10 minutes. Viscosity is equal to an inverse of the MVR.

Weight average molecular weight (Mw) was determined by gel permeation chromatography (GPC) as described above.

The overall microstructural properties of polymer/graphene nanocomposites were studied by scanning electron microscopy (SEM).

Specific surface area (porosity) was determined using SEM. Scanning electron microscope (ESEM, JSF 7800F, JEOL, Tokyo, Japan) was used to acquire micrographs of graphene nanocomposite 3D sponge and microstructures and fiber like microstructures with dispersion of graphene nanoparticles at an acceleration voltage of 10 kV. For SEM examination, the samples were sputter-coated with pd/Pt. Results are reported in units of m².g⁻¹.

Raman spectroscopy (Bruker Senterra dispersive microscope Raman) was used to confirm creation of graphene after laser irradiation for various samples at laser wavelength 532 nm (2 Mw) with objective of 100× in scanning range 4400-200 cm⁻¹.

Degree of graphitization was determined by calculating intensity of peaks (2D, G, D) position, shape of spectra, according to ISO TC 201 (Surface Chemical Analysis) and further in accordance with the Versailles Project on Advanced Materials and Standards by VAMAS TWA41—Graphene and VAMAS TWA42—Raman.

Electrical volume resistivity measurements were conducted in a thickness direction using Jandel 4-point probe with spacing of 1 mm at 90 volts (V), according to ASTM 257-75, and converted to conductivity values. Each conductivity value reported is an average of the calculated conductivity at ten locations along a line on the sample. Results are reported in units of S/m.

As used herein, “2D band” can be correlated to a single graphene layer. Single layer graphene can also be identified by analyzing the peak intensity ratio of the 2D and G bands.

The adhesion of graphene particles to the polymer were determined by tape file, and are reported relative to each other, where each “+” indicates better adhesion.

Absorption measurements were performed in attenuated total reflection (ATR) mode of Fourier transform infrared spectrometer (FTIR, spectrum 100, Perkin Elmer, Shelton, USA) on film samples with thickness of 50 μm-1000 μm and further measurement was confirmed on raw powders. Absorbance values can be determined for specific wavelengths and are determined by converting from wavenumber, reported in cm⁻¹, to wavelength, reported in μm or nm.

The compositions of Examples 1-4 (Ex1-4) and Comparative Examples 1-4 (CEx1-4) are shown, together with their measured properties. The amount of each component is in volume percent, based on the total volume of the composition, and totals 100.00 volume percent. The MVR of Comparative Examples 1 and 2 and Examples 1 and 2 was determined at 300° C./1.2 kg in accordance with ISO 1133, and the MVR of Comparative Examples 3 and 4 and Examples 3 and 4 was determined at 360° C./5.0 kg in accordance with ISO 1133.

TABLE 3

| | CEx1 | Ex1 | CEx2 | Ex2 | CEx3 | Ex3 | CEx4 | Ex4 |
|---|---|---|---|---|---|---|---|---|
| Component | | | | | | | | |
| PEI | | | | | 50.00 | 49.00 | 50.00 | 49.00 |
| PC-1 | 65.00 | 64.00 | | | 32.5 | 32.00 | | |
| PC-2 | 34.67 | 33.67 | | | 17.34 | 16.84 | | |
| ITR-PC | | | 100.00 | 98.00 | | | 50.00 | 49.00 |
| PETS | 0.27 | 0.27 | | | 0.13 | 0.13 | | |
| AO | 0.06 | 0.06 | | | 0.03 | 0.03 | | |
| Mica-1 | | 2.00 | | 2.00 | | 2.00 | | 2.00 |
| Properties | | | | | | | | |
| MVR (300° C./1.2 kg) | 12 | 12 | 9 | 9 | | | | |
| MVR (360° C./5.0 kg) | | | | | 14.5 | 14.5 | 13 | 13 |
| Mw PC composition | 27.0 | 27.0 | − | − | 39.8 | 39.8 | − | − |
| Electrical conductivity before | 0 | 0 | 0 | 0 | 0 | 0 | 0 | 0 |
| laser irradiation | | | | | | | | |
| Electrical conductivity after | 0 | 10 | 70 | 120 | 170 | 200 | 150 | 200 |
| laser irradiation | | | | | | | | |
| Porosity before laser irradiation | 0 | 0 | 0 | 0 | 0 | 0 | 0 | 0 |
| Porosity after laser irradiation | 0 | 50 | 300 | 300 | 250 | 250 | 280 | 280 |
| Degree of graphitization before | 0 | 0 | 0 | 0 | 0 | 0 | 0 | 0 |
| laser irradiation | | | | | | | | |
| Degree of graphitization after | 0 | 0.71 | 0.76 | 0.76 | 0.70 | 0.80 | 0.70 | 0.80 |
| laser irradiation | | | | | | | | |
| Adhesion of graphene particles | − | + | + | + | ++ | ++ | ++ | ++ |
| on polymer | | | | | | | | |

### Comparative Example 1 and Example 1—Polycarbonate

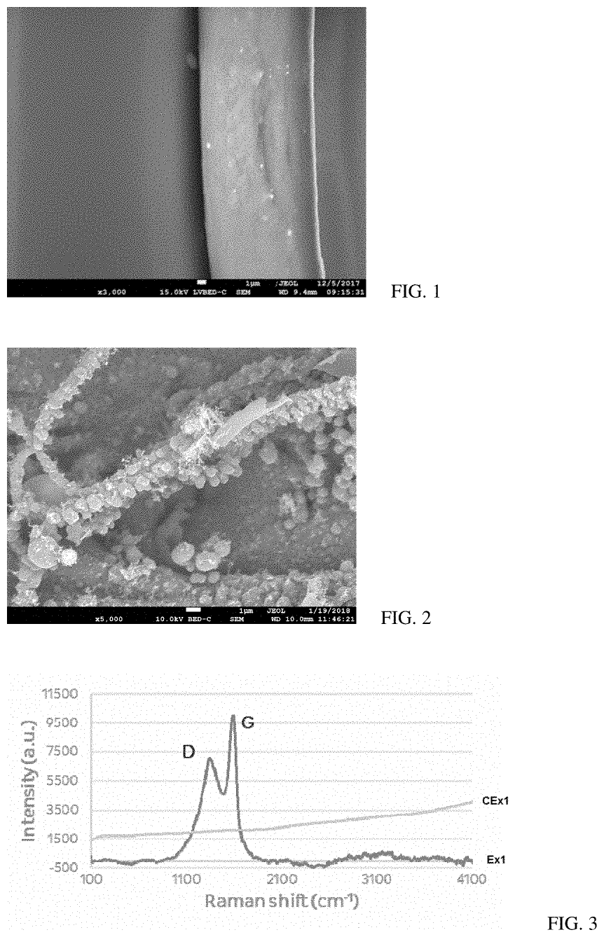

An SEM image of a clear blend of polycarbonates containing no mica (CEx1) showed no pores in the microstructure after laser irradiation (FIG. 1, showing smooth surfaces). An SEM image of the same polycarbonate blend containing mica-1 (Ex1) showed formation and dispersion of graphene particles on the surface after laser irradiation (FIG. 2, showing formation of graphene particles colonized on fiber-like microstructures).

Raman spectroscopy confirmed that CEx1 was not graphitized by laser irradiation (FIG. 3). Raman spectroscopy confirmed graphitization of Ex1 by laser irradiation, by the presence of D and G bands (FIG. 3).

### Comparative Example 3 and Example 3—Polycarbonate and PEI

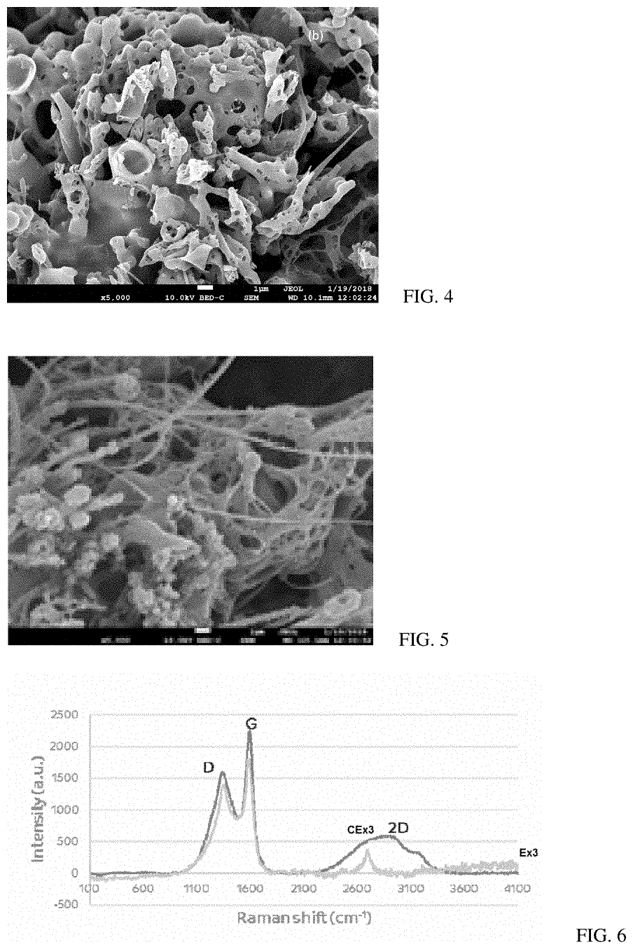

An SEM image of PC-1/PC-2/PEI (immiscible blend) containing no mica (CEx3) showed porous microstructures after laser irradiation (FIG. 4). An SEM image of the same PC-1/PC-2/PEI containing mica-1 (Ex3) showed a different morphology with increasing fiber-like graphene nanocomposites after laser irradiation (FIG. 5). The nanocomposite properties of such 3-dimensional pores microstructures may provide improved electrochemical properties.

Comparing Raman spectrum after laser irradiation, the 2D peak became sharper, e.g., more defined, in Ex3 as compared to CEx3, which is indicative of conversion of polymer to graphene and an increased degree of graphitization for PC-1/PC-2/PEI. Additionally, a smaller FWHM (full width at half maximum) in Ex3 as compared to CEx3 is indicative of a higher degree, e.g., amount, of single graphene (FIG. 6).

### Comparative Example 4 and Example 4—ITR-PC and PEI

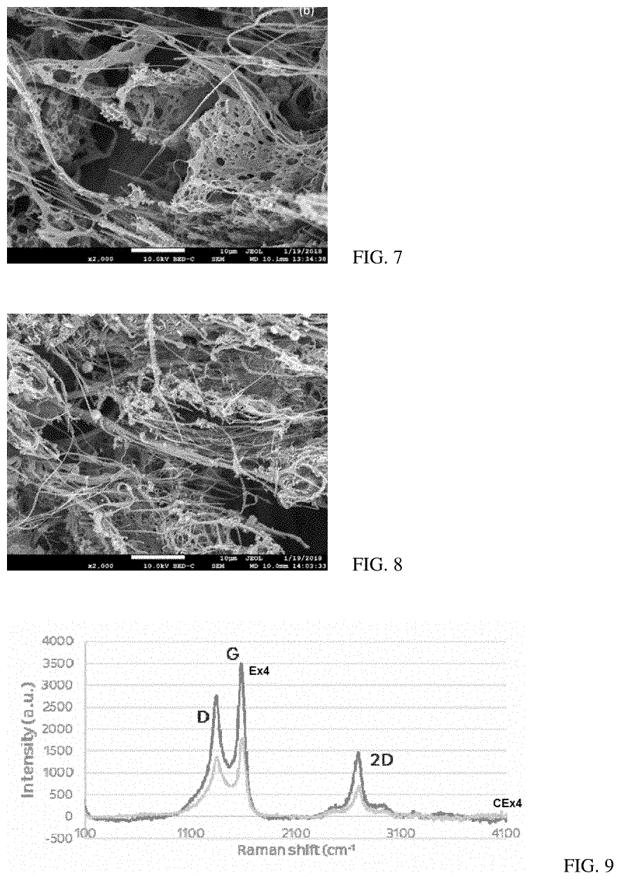

An SEM image of ITR-PC/PEI (miscible blend) containing no mica (CEx4) showed porous microstructures after laser irradiation (FIG. 7). An SEM image of the same ITR-PC/PEI containing mica-1 (Ex4) showed a different morphology with increasing fiber-like graphene nanocomposites after laser irradiation (FIG. 8).

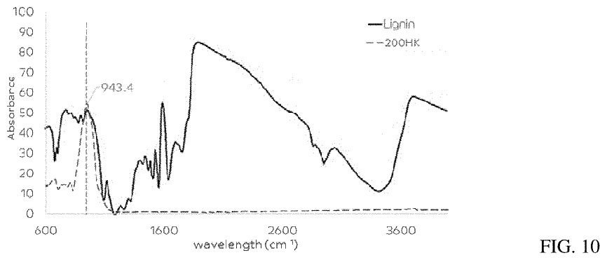

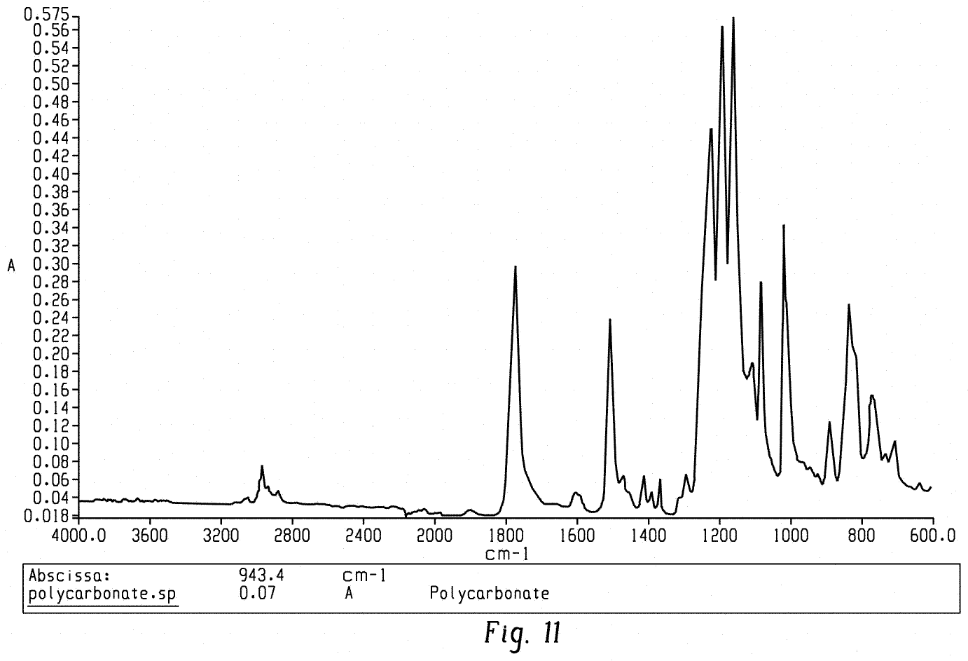

Comparing Raman spectrum after laser irradiation, an intensity of the 2D peak increased in Ex4 as compared to CEx4, which is indicative of an increased degree of graphitization for ITR-PC/PEI (FIG. 9).

The compositions of Examples 5-9 (Ex5-9) and Comparative Example 5 (CEx5) are shown in Table 4, together with their measured properties. The amount of each component is in volume percent, based on the total volume of the composition, and totals 100.00 volume percent. “NA” indicates that the data is not available. The definition of Y for degree of graphitization is a value greater than 0.1. The definition of Y for electrical conductivity after laser irradiation is a value greater than 10 (S/m).

TABLE 4

| | CEx 5 | Ex 5 | Ex 6 | Ex 7 | Ex 8 | CEx 9 | Ex 10 | Ex 11 | Ex 12 | Ex 13 | CEx 14 | Ex 15 | Ex 16 | Ex 17 | Ex 18 |
|---|---|---|---|---|---|---|---|---|---|---|---|---|---|---|---|
| Component | | | | | | | | | | | | | | | |
| PEI | | | | | | 100 | 98 | 98 | 98 | 98 | | | | | |
| PC-1 | 50 | 49 | 49 | 49 | 49 | | | | | | | | | | |
| PC-2 | 50 | 49 | 49 | 49 | 49 | | | | | | | | | | |
| ITR-PC | | | | | | | | | | | 100 | 98 | 98 | 98 | 98 |
| Total polymers | 100.00 | 98.00 | 98.00 | 98.00 | 98.00 | 100 | 98 | 98 | 98 | 98 | 100 | 98 | 98 | 98 | 98 |
| Lignin | | 2.00 | | | | | 2 | | | | | 2 | | | |
| Mica-2 | | | 2.00 | | | | | 2 | | | | | 2 | | |
| Resol resins | | | | 2.00 | | | | | 2 | | | | | 2 | |
| Phenol | | | | | 2.00 | | | | | 2 | | | | | 2 |
| formaldehyde resin | | | | | | | | | | | | | | | |
| Properties | | | | | | | | | | | | | | | |
| Electrical | 0 | 0 | 0 | 0 | 0 | 0 | 0 | 0 | 0 | 0 | 0 | 0 | 0 | 0 | 0 |
| conductivity before | | | | | | | | | | | | | | | |
| laser irradiation | | | | | | | | | | | | | | | |
| Electrical | N | Y | Y | Y | Y | Y | Y | Y | Y | Y | Y | Y | Y | Y | Y |
| conductivity after | | | | | | | | | | | | | | | |
| laser irradiation | | | | | | | | | | | | | | | |
| Degree of | 0 | 0 | 0 | 0 | 0 | 0 | 0 | 0 | 0 | 0 | 0 | 0 | 0 | 0 | 0 |
| graphitization | | | | | | | | | | | | | | | |
| before laser | | | | | | | | | | | | | | | |
| irradiation | | | | | | | | | | | | | | | |
| Degree of | N | Y | Y | Y | Y | Y | Y | Y | Y | Y | Y | Y | Y | Y | Y |
| graphitization after | | | | | | | | | | | | | | | |
| laser irradiation | | | | | | | | | | | | | | | |

FIG. 10 is a Fourier-transform infrared spectrum of mica used in Examples 1-4 and lignin used in Examples 5, 10, and 15. FIG. 11 is a Fourier-transform infrared spectrum of unfilled PC-1 without pigments (Mica-1).

This disclosure further encompasses the following aspects.

Aspect 1. A method for forming a polymer/graphene nanocomposite, the method comprising providing a polymer matrix comprising a clear polymer and an additive effective to induce graphitization of the polymer at a wavelength in a range of 8.3 to 11 μm, or 8.3 to 10.6; and irradiating the polymer matrix with radiation comprising a wavelength in a range of 8.3 to 11 μm, or 8.3 to 10.6 μm to provide the polymer/graphene nanocomposite, optionally wherein the clear polymer has a haze of less than 15%, or less than 10%, or less than 5%, or less than 1%, each measured according to ASTM D1003-00 using the color space CIE1931 (Illuminant C and a 2° observer) at a sample thickness of 2.5 mm.

Aspect 2. The method according to Aspect 1, wherein the clear polymer comprises a cyclic olefin polymer, fluoropolymer, polyacetal, poly(C₁₋₆ alkyl)acrylate, polyacrylamide, polyacrylonitrile, polyamide, polyamideimide, polyanhydride, polyarylene ether, polyarylene ether ketone, polyarylene ketone, polyarylene sulfide, polyarylene sulfone, polybenzothiazole, polybenzoxazole, polybenzimidazole, polycarbonate, polyester, polyetherimide, polyimide, poly(C1-6 alkyl)methacrylate, polymethacrylamide, polyolefin, polyoxadiazole, polyoxymethylene, polyphthalide, polysilazane, polysiloxane, polystyrene, polysulfide, polysulfonamide, polysulfonate, polythioester, polytriazine, polyurea, polyurethane, vinyl polymer, a thermosetting alkyd, bismaleimide polymer, bismaleimide triazine polymer, cyanate ester polymer, benzocyclobutene polymer, diallyl phthalate polymer, epoxy, hydroxymethylfuran polymer, melamine-formaldehyde polymer, phenolic polymer, benzoxazine, polydiene, polyisocyanate, polyurea, polyurethane, silicone, triallyl cyanurate polymer, triallyl isocyanurate polymer, or a combination thereof; preferably wherein the clear polymer comprises a polyamide, polycarbonate, polyester, polyetherimide, poly(C1-6 alkyl)(meth)acrylate, poly(methyl adamantine methacrylate), polypropylene, poly(methyl methacrylate), polystyrene, melamine-formaldehyde polymer, poly(arylene ether), poly(p-phenylene oxide), polyurethane, or a combination thereof polymers; most preferably wherein the clear polymer comprises a polycarbonate, polyetherimide, or a combination thereof.

Aspect 3. The method according to any preceding aspect, wherein the clear polymer comprises at least one polycarbonate, wherein the polycarbonate is a polycarbonate homopolymer, copolycarbonate, poly(carbonate-ester), poly(carbonate-siloxane), poly(carbonate-ester-siloxane), or a combination thereof polymers; preferably wherein the clear polymer comprises a poly(carbonate-ester).

Aspect 4. The method according to Aspect 3, wherein the clear polymer further comprises a polyetherimide.

Aspect 5. The method according to Aspect 4, wherein the clear polymer comprises the polycarbonate in an amount of 10 to 90 volume percent; and the polyetherimide in an amount of 90 to 10 volume percent, each based on a total volume of the clear polymer.

Aspect 6. The method according to Aspect 4, wherein the clear polymer comprises the poly(carbonate-ester) in an amount of 10 to 90 volume percent; and the polyetherimide in an amount of 90 to 10 volume percent, each based on a total volume of the clear polymer.

Aspect 7. The method according to any preceding aspect, wherein the additive has an absorbance of greater than 2 in a range of 9 to 11 μm, more preferably 10.4 to 10.8 μm.

Aspect 8. The method according to any preceding aspect, wherein the additive comprises mica, a phenol resin, a pigment, a dye, a biopolymer, biomass, cellulose, lignin, or a combination thereof.

Aspect 9. The method according to any preceding aspect, wherein the additive is present in an amount of 0.05 to 15 volume percent, preferably 0.1 to 10 volume percent, more preferably 0.5 to 5 volume percent, based on a total volume of the polymer matrix.

Aspect 10. The method according to any preceding aspect, wherein the unfilled polymer matrix has an absorbance of less than 1 in a range of 9 to 11 μm, more preferably 10.4 to 10.8 μm.

Aspect 11. The method according to any preceding aspect, comprising irradiating the polymer matrix using a laser, wherein the operating conditions of the laser comprise a power in a range of 0.1 to 0.6 W, a laser speed in a range of 1.7 to 2.5 cm s⁻¹, a pulse duration in a range of 10 to 30 μs, and a resolution in a range of 500 to 1,000 ppi.

Aspect 12. The method according to Aspect 11, further comprising adjusting one or more of the operating conditions of the laser to adjust a property of the polymer/graphene nanocomposite.

Aspect 13. The method according to any preceding aspect, wherein the polymer/graphene nanocomposite has at least one of an electrical conductivity of 1 to 2,000 S/m, measured according to ASTM 257-75, or a degree of graphitization of 0.5 to 2.0, measured according to ISO TC 201 (Surface Chemical Analysis) and further Versailles Project on Advanced Materials and Standards by VAMAS TWA41—Graphene and VAMAS TWA42—Raman.

Aspect 14. The method according to any preceding aspect, wherein the polymer/graphene nanocomposite has a greater degree of adhesion compared to a second polymer matrix comprising the same clear polymer without the additive, the second polymer matrix having been irradiated with radiation comprising a wavelength in a range of 8.3 to 11 μm.

Aspect 15. A polymer/graphene nanocomposite made by the method of any preceding aspect.

Aspect 16. A polymer/graphene nanocomposite comprising: a clear polymer; an additive effective to induce graphitization of the polymer at a wavelength in a range of 8.3 to 11 μm; and polymer-derived graphene.

Aspect 17. An article comprising the polymer/graphene nanocomposite of Aspect 15 or Aspect 16.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. The term “a combination thereof” in reference to a list of alternatives is open, i.e., includes at least one of the listed alternatives, optionally with a like alternative nots listed. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method for forming a polymer/graphene nanocomposite, the method comprising:
providing a polymer matrix comprising a clear polymer and an additive effective to induce graphitization of the polymer at a wavelength in a range of 8.3 to 11 μm; and
irradiating the polymer matrix with radiation comprising a wavelength in a range of 8.3 to 11 μm to provide the polymer/graphene nanocomposite.

2. The method according to claim 1, wherein the clear polymer comprises a cyclic olefin polymer, fluoropolymer, polyacetal, poly(C1-6 alkyl)acrylate, polyacrylamide, polyacrylonitrile, polyamide, polyamideimide, polyanhydride, polyarylene ether, polyarylene ether ketone, polyarylene ketone, polyarylene sulfide, polyarylene sulfone, polybenzothiazole, polybenzoxazole, polybenzimidazole, polycarbonate, polyester, polyetherimide, polyimide, poly(C1-6 alkyl)methacrylate, polymethacrylamide, polyolefin, polyoxadiazole, polyoxymethylene, polyphthalide, polysilazane, polysiloxane, polystyrene, polysulfide, polysulfonamide, polysulfonate, polythioester, polytriazine, polyurea, polyurethane, vinyl polymer, a thermosetting alkyd, bismaleimide polymer, bismaleimide triazine polymer, cyanate ester polymer, benzocyclobutene polymer, diallyl phthalate polymer, epoxy, hydroxymethylfuran polymer, melamine-formaldehyde polymer, phenolic polymer, benzoxazine, polydiene, polyisocyanate, polyurea, polyurethane, silicone, triallyl cyanurate polymer, triallyl isocyanurate polymer, or a combination thereof.

3. The method according to claim 1, wherein the clear polymer comprises a polyamide, polycarbonate, polyester, polyetherimide, poly(C1-6 alkyl)(meth)acrylate, poly(methyl adamantine methacrylate), polypropylene, poly(methyl methacrylate), polystyrene, melamine-formaldehyde polymer, poly(arylene ether), poly(p-phenylene oxide), polyurethane, or a combination thereof.

4. The method according to claim 1, wherein the clear polymer comprises a polycarbonate, polyetherimide, or a combination thereof.

5. The method according to claim 1, wherein the clear polymer comprises at least one polycarbonate, wherein the polycarbonate is a polycarbonate homopolymer, copolycarbonate, poly(carbonate-ester), poly(carbonate-siloxane), poly(carbonate-ester-siloxane), or a combination thereof.

6. The method according to claim 1, wherein the clear polymer comprises a poly(carbonate-ester).

7. The method according to claim 5, wherein the clear polymer further comprises a polyetherimide.

8. The method according to claim 5, wherein the clear polymer comprises the polycarbonate in an amount of 10 to 90 volume percent and the polyetherimide in an amount of 90 to 10 volume percent, each based on a total volume of the clear polymer.

9. The method according to claim 6, wherein the clear polymer comprises the poly(carbonate-ester) in an amount of 10 to 90 volume percent and the polyetherimide in an amount of 90 to 10 volume percent, each based on a total volume of the clear polymer.

10. The method according to claim 1, wherein the additive has an absorbance of greater than 2 in a range of 9 to 11 μm.

11. The method according to claim 1, wherein the additive comprises mica, a phenol resin, a pigment, a dye, a biopolymer, a cellulose, a lignin, or a combination thereof.

12. The method according to claim 1, wherein the additive is present in an amount of 0.05 to 15 volume percent, based on a total volume of the polymer matrix.

13. The method according to claim 1, wherein the unfilled polymer matrix has an absorbance of less than 1 in a range of 9 to 11 μm.

14. The method according to claim 1, comprising irradiating the polymer matrix using a laser, wherein the operating conditions of the laser comprise:
a power in a range of 0.1 to 0.6 W,
a laser speed in a range of 1.7 to 2.5 cm s⁻¹,
a pulse duration in a range of 10 to 30 μs, and
a resolution in a range of 500 to 1,000 ppi.

15. The method according to claim 14, further comprising adjusting one or more of the operating conditions of the laser to adjust a property of the polymer/graphene nanocomposite.

16. The method according to claim 1, wherein the polymer/graphene nanocomposite has at least one of:
an electrical conductivity of 1 to 2,000 S/m, measured according to ASTM 257-75, or
a degree of graphitization of 0.5 to 2.0, measured according to ISO TC 201 (Surface Chemical Analysis) and further according to the Versailles Project on Advanced Materials and Standards by VAMAS TWA41—Graphene and VAMAS TWA42—Raman.

17. The method according to claim 1, wherein the polymer/graphene nanocomposite has a greater degree of adhesion compared to a second polymer matrix comprising the same clear polymer without the additive, the second polymer matrix having been irradiated with radiation comprising a wavelength in a range of 8.3 to 11 μm.

18. A polymer/graphene nanocomposite formed by the method of claim 1.

19. A graphitized polymer composition comprising:
a clear polymer;
an additive effective to induce graphitization of the polymer at a wavelength in a range of 8.3 to 11 μm; and
polymer-derived graphene.

20. An article comprising the polymer/graphene nanocomposite of claim 19.
